(19) United States
(12) Patent Application Publication
(10) Pub. No.: US 2018/0183917 A1
(43) Pub. Date: Jun. 28, 2018

(54) USER DEVICES, METHODS, AND NON-TRANSITORY COMPUTER-READABLE STORAGE MEDIA

(71) Applicant: Metaswitch Networks Ltd, Enfield (GB)

(72) Inventors: David William Maxwell REEKIE, Enfield (GB); Diarmid Hugh MACKENZIE, Enfield (GB); Mark Edward BERRY, Enfield (GB); Nicholas David BUTCHER, Enfield (GB)

(21) Appl. No.: 15/849,509

(22) Filed: Dec. 20, 2017

(30) Foreign Application Priority Data
Dec. 22, 2016 (GB) 1622053.5

(51) Int. Cl. H04M 1/27; H04M 1/725; H04W 4/14

(52) U.S. Cl. CPC H04M 1/271; H04M 1/7258; H04W 4/14; H04M 1/72552; H04M 1/72561; H04M 1/72583

(57) ABSTRACT

A telecommunications user device 10 comprises a native telecommunications function 11 operable to conduct telecommunications with a telecommunications function 31 of a telecommunications device 30 via a telecommunications function 21 of telecommunications network equipment 20. The telecommunications user device 10 also comprises a data processing function 12 operable to cause, in response to a trigger event, data based on content received by the telecommunications user device 10 to be displayed on the telecommunications user device 10, and to perform an action based on user input received by the telecommunications user device 10 in response to displaying the data.

### CROSS-REFERENCE TO RELATED APPLICATIONS

This application claims the benefit under 35 U.S.C. § 119(a) and 37 CFR § 1.55 to UK Patent Application No. 1622053.5, filed on Dec. 22, 2016, the entire content of which is incorporated herein by reference.

### BACKGROUND OF THE INVENTION

### Field of the Invention

The present invention relates to telecommunications user devices, telecommunications network equipment, methods, computer programs, computer-readable media, smartphones and interactive voice response systems.

### Description of the Related Technology

Telecommunications can be conducted between telecommunications user devices in a telecommunications network. For example, telephone calls can be conducted between telephony user devices in a telephony network. Although mechanisms are known for enhancing such telecommunications, it would be desirable to provide additional mechanisms for enhancing such telecommunications.

### SUMMARY

According to first embodiments, there is provided a telecommunications user device comprising:

a native telecommunications function operable to establish a telephone call with a telecommunications function of a telecommunications device via a telecommunications function of telecommunications network equipment; and

a data processing function operable to:

receive content from the telecommunications network equipment and/or further telecommunications network equipment;

cause data based on the content received by the telecommunications user device to be displayed on the telecommunications user device after the telephone call is established between the native telecommunications function and the telecommunications function of the telecommunications device, the displayed data comprising an indication of an alternative telecommunications mechanism for conducting telecommunications with an entity associated with the telecommunications device, the alternative telecommunications mechanism being different from a telephone call; and

cause the telephone call established with the telecommunications function of the telecommunications device to be terminated based on user input received by the telecommunications user device in response to the displaying of the data.

According to second embodiments, there is provided a method of controlling a telecommunications user device, the telecommunications user device comprising:

a native telecommunications function operable to establish a telephone call with a telecommunications function of a telecommunications device via a telecommunications function of telecommunications network equipment; and

a data processing function,

wherein the method comprises:

the data processing function receiving content from the telecommunications network equipment and/or further telecommunications network equipment;

the data processing function causing data based on the content received by the telecommunications user device to be displayed on the telecommunications user device after the telephone call is established between the native telecommunications function and the telecommunications function of the telecommunications device, the displayed data comprising an indication of an alternative telecommunications mechanism for conducting telecommunications with an entity associated with the telecommunications device, the alternative telecommunications mechanism being different from a telephone call; and

the data processing function causing the telephone call established with the telecommunications function of the telecommunications device to be terminated based on user input received by the telecommunications user device in response to the displaying of the data.

According to third embodiments, there is provided A non-transitory computer-readable storage medium comprising a set of computer-readable instructions stored thereon, which, when executed by a processing system, cause the processing system to perform a method of controlling a telecommunications user device, the telecommunications user device comprising:

a native telecommunications function operable to establish a telephone call with a telecommunications function of a telecommunications device via a telecommunications function of telecommunications network equipment; and

a data processing function,

wherein the method comprises:

the data processing function receiving content from the telecommunications network equipment and/or further telecommunications network equipment;

the data processing function causing data based on the content received by the telecommunications user device to be displayed on the telecommunications user device after the telephone call is established between the native telecommunications function and the telecommunications function of the telecommunications device, the displayed data comprising an indication of an alternative telecommunications mechanism for conducting telecommunications with an entity associated with the telecommunications device, the alternative telecommunications mechanism being different from a telephone call; and

the data processing function causing the telephone call established with the telecommunications function of the telecommunications device to be terminated based on user input received by the telecommunications user device in response to the displaying of the data.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a schematic block diagram of an example of a telecommunications network in accordance with an embodiment of the present invention;

FIG. 2 shows a sequence diagram depicting an example of a method in accordance with an embodiment of the present invention;

FIG. 3 shows a sequence diagram depicting another example of a method in accordance with an embodiment of the present invention; and

FIG. 4 shows a sequence diagram depicting another example of a method in accordance with an embodiment of the present invention.

### DETAILED DESCRIPTION OF CERTAIN INVENTIVE EMBODIMENTS

Examples described herein relate to providing enhanced telecommunications between telecommunications devices. As used herein, the term “telecommunications” relates to communication (or ‘transfer’) of information, data, signals, messages, media etc. Telecommunications may be conducted, for example, by radio, optical, wireline and/or other types of media.

Some examples described herein relate to enhancing a dialer function or other telecommunications function (such as a messaging function) of a telecommunications user device such as a smartphone. An enhanced dialer function, such as that described herein, may assist users in making calls, thereby providing an enhanced user experience and an opportunity for additional services and functionality to be made available to the user. In addition to enhancing user experience, examples described herein may facilitate traffic and/or resource management in a telecommunications network, for example by suggesting alternative telecommunications options to a user where a telecommunications option initially selected by the user would result in undesirable traffic and/or resource usage in the telecommunications network. Examples of such alternative telecommunications options include, but are not limited to, alternative telecommunications identifiers and/or telecommunications mechanisms.

As such, some examples described herein relate to dynamically providing an alternative suggestion for telecommunications with the same or another entity. In some examples, an alternative telecommunications identifier, such as an alternative telephone number, to an initially indicated telecommunications identifier is suggested. The alternative telecommunications identifier may relate to the same entity as that associated with the initially entered or selected telecommunications identifier or may relate to a different entity. For example, a user may initially desire to communicate with a given entity and may be provided with a suggestion to communicate with a different entity instead. For example, the given entity and the different entity may be competitors of each other. As such, examples described herein allow for competitive advertising and/or competitor telecommunications identifiers to be provided (or ‘pushed’) to a user. In some examples, an alternative telecommunications mechanism to an initially indicated telecommunications mechanism is suggested. For example, an entity may initially wish to conduct telephony communications with another entity and an alternative telecommunications mechanism, such as an instant messaging (IM) mechanism, a given software application, website, chat session (for example with a chat bot) or function, may be suggested as an alternative. Such suggestions may be provided at the point of initiating such telecommunications, for example at the point of initiating a telephone call. Such telecommunications may be initiated in various different ways. For example, such telecommunications may be initiated by a user entering a telecommunications identifier into a dialer function of a telecommunications user device, by the user selecting an entity with whom they wish to conduct telecommunications from an address book (or ‘contact’) function of a telecommunications user device, by speaking the name of the entity with whom they wish to conduct telecommunications in association with a dial-by-voice function of a telecommunications user device and/or by selecting a “call me” link in a website displayed by a web browser function of a telecommunications user device. Telecommunications can be initiated in other ways.

A user of the telecommunications user device may thereby be provided with additional information, for example when initiating a telephone call, to help the user make an informed choice about which telecommunications identifier (for example telephone number, session initiation protocol (SIP) identifier, email address, etc.) and/or telecommunications mechanism (for example telephone call, web browsing, instant messaging etc.) they wish to use for such telecommunications. Where the user selects, via predetermined user input, that they wish to use an alternative telecommunications identifier for such telecommunications, they can be seamlessly assisted in using the alternative telecommunications identifier for such telecommunications instead of an initially indicated telecommunications identifier.

In some examples, a native dialer function of an Internet-connected telecommunications user device (such as a smartphone) may be configured or updated such that, once a telephone call has been initiated by the user, but prior to initiating a call setup with the telecommunications network, the telecommunications user device issues a request for content. In some examples, such content may be requested after call setup is initiated by the user. In some such examples, such content may be requested after call setup with the telecommunications network is initiated. The request may be issued to telecommunications network equipment, such as a remote server. The request may be issued via a public network, such as the Internet, and/or via a private network. The request may comprise information related to the user, a dialed number and/or another type of identifier, and/or a current location of the user. The request may use the hypertext transfer protocol (HTTP), the secure hypertext transfer protocol (HTTPS), SIP, Internet message access protocol (IMAP), extensible messaging and presence protocol (XMPP) and/or another data communication protocol. The telecommunications network equipment may respond with a selection of one or more suggested numbers to dial, and/or one or more non-telephony uniform resource locators (URLs) to use, for example together with images and text associated with that suggestion, such as a logo, details of a special offer and call rates. The telecommunications network equipment may provide content such as images and text directly, or may provide data identifying further telecommunications network equipment (for example a further server) at which such content may be obtained. On receipt of the content (from the telecommunications network equipment or elsewhere), the dialer function, or another function, may cause the suggestions to be displayed on the screen of the telecommunications user device and invite the user to select an option to call, send a message etc. The dialer function may also play an audio message and/or generate another type of alert to indicate to the user that multiple suggestions are available. As such, a user who has already put the telecommunications user device to their ear in anticipation of speaking to another call party can be prompted to make a selection from the suggested options.

The suggestions served up by the telecommunications network equipment may be derived by algorithms using a range of information including, but not limited to, the directory number of the user, any other information that is known to the telecommunications network equipment in relation to the user who owns the directory number, the location of the user, the time of day, and the dialed number.

The telecommunications network equipment may offer application programming interfaces (APIs) to third parties. This may allow such third parties to dynamically update content and policies used to generate suggestions. Such updates may be used, for example, to attract more traffic to a business at quiet times and/or to direct traffic away from a business at busy times.

Examples described herein may be used, for example, to promote alternative telephone services. Examples of such alternative telephone services include, but are not limited to, low-cost calling services, for example cheap international calls, cheaper calls to premium rate numbers and/or or alternative directory assistance services. Examples described herein may be used to promote alternative, non-telephone services that are commonly purchased by telephone call. Examples of such non-telephone services include, but are not limited to take-out food, breakdown cover and insurance. Examples described herein may be used to divert (or “transition”) telephone calls to alternative communication channels, for example an alternative software application, a website and/or a chat session (for example with a chat bot).

Examples described herein differ from known smart dialers, which may suggest a range of possible telephone numbers that could be called based on a series of entered dialed digits. In such known smart dialers, the suggestions are based on locally stored contact information that is manually entered into the phone by the user. Such information may be relatively limited in scope and relatively static. Known smart dialers may also only be able to provide such suggestions for a relatively small number of methods of initiating a telephone call, for example by entering a telephone number into the dialer using a numerical dial pad. Such known smart dialers may be unable to provide such suggestions for other methods of initiating a telephone call, such as by using dial-by-voice, or via a “call me” link on a website. By obtaining suggestion information from a remote source, such as a web server, in contrast to using static contacts data stored locally on the telecommunication user device, suggestions may be tailored more specifically to the user, the time and/or location of the telecommunications. Input from a wider range of interested parties, including advertisers, may also be incorporated. Additionally, in examples described herein, the suggestion functionality may be invoked for additional methods of call initiation, such as dial-by-voice or via a “call me” link on a website.

Examples described herein also differ from known techniques in which a uniform resource locator (URL) or search term is entered into an omnibox in a web browser. In such techniques, the web browser may suggest alternative URLs or search terms. Similarly, after submitting an internet search, a user may be offered a range of suggested websites, based on the search terms they have entered. However, these techniques have not been used, for example, in relation to users making telephone calls. In some examples described herein, suggestion functionality may be seamlessly integrated into a native dialer and/or messaging function of a telecommunications user device.

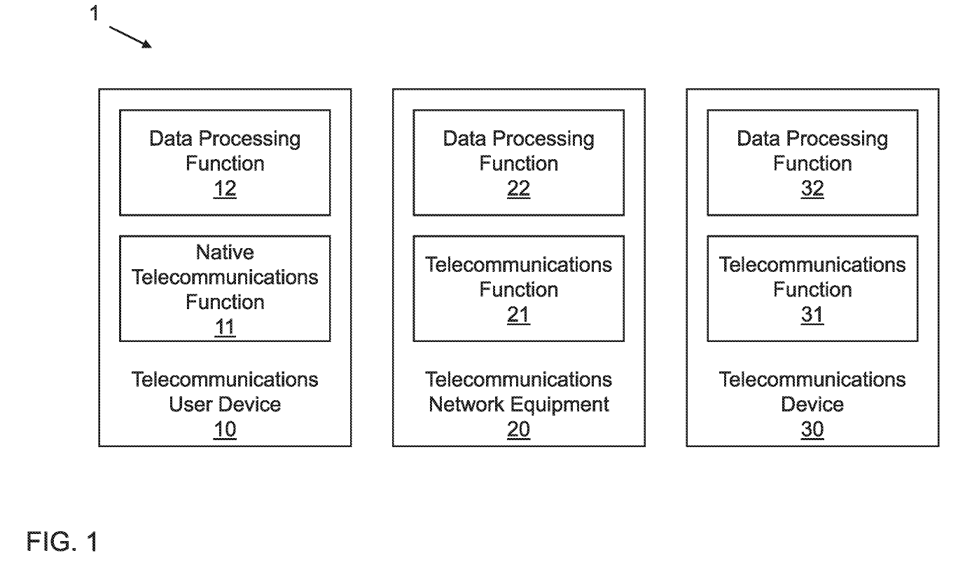

Referring now to FIG. 1, there is shown an example of a telecommunications network 1. The telecommunications network 1 enables telecommunication to be conducted between entities in the telecommunications network 1. The telecommunications network 1 may be or may comprise a telephony network, such as a mobile telephony network.

The telecommunications network 1 may support telephony communications, short messaging service (SMS) communications, multimedia messaging service (MMS) communications, SIP-based messaging and/or other types of telecommunications. An example of SIP-based messaging is Rich Communication Services (RCS) communications.

In this example, the telecommunications network 1 comprises a telecommunications user device 10, telecommunications network equipment 20 and a telecommunications device 30. The telecommunications user device 10 and/or the telecommunications device 30 may be able to communicate with the telecommunications network equipment 20 via a physical connection and/or a wireless connection. Some or all of the telecommunications user device 10, the telecommunications network equipment 20 and the telecommunications device 30 may be located remotely from each other in the telecommunications network 1. The telecommunications network equipment 20 may be controlled by a mobile network operator. Communications conducted via the telecommunications network equipment 20 may be tracked by the mobile network operator so that the user of the telecommunications user device 10 may be charged for such communications or such communications can be accounted for as part of a service contract with the mobile network operator.

The telecommunications user device 10 may be a mobile telecommunications user device or a non-mobile telecommunications user device. Examples of telecommunications user devices include, but are not limited to, smartphones, tablet computing devices, laptop computing devices, desktop computing devices, smart televisions, computer games consoles, wearable computing devices and personal digital assistants.

The telecommunications network equipment 20 may comprise one or more servers. In some examples, the telecommunications network equipment is or comprises a telecommunications application server, such as a telephony application server. An example of a telephony application server is a SIP application server. The telecommunications network equipment 20 may comprise one or more physical resources and/or one or more virtualized resources. Where the telecommunications network equipment comprises multiple resources, the resources may be co-located or may be located remotely from each other. The telecommunications network equipment 20 may be any type of equipment with which telecommunications may be conducted. Examples of such telecommunications include, but are not limited to, transfer of data, information, signals, messages and media.

The telecommunications device 30 may be a telecommunications user device or may be another type of telecommunications device. Examples of other types of telecommunications device include, but are not limited to, an interactive voice response (IVR) system, an automatic call distributor (ACD) as may be provided for a call center, or the like. The telecommunications device 30 may serve as an intermediary between the telecommunications user device 10 and one or more telecommunications user devices. For example, the user of the telecommunications user device 10 may call an ACD of a call center (rather than a predetermined individual agent in the call center) and the suggestion functionality described herein may be provided in relation to the call center (rather than a predetermined one of the agents in the call center).The telecommunications user device 10, telecommunications network equipment 20 and telecommunications device 30 each comprises a respective telecommunications function 11, 21, 31 and a respective data processing function 12, 22, 32. A telecommunications function provides telecommunications functionality and a data processing function provides data processing functionality. The telecommunications function and/or the data processing function may be embodied in hardware and/or software. The telecommunications functions 11, 21, 31 and data processing functions 12, 22, 32 may be logically separate components of the telecommunications user device 10, the telecommunications network equipment 20 and the telecommunications device 30.

In this example, the telecommunications function 11 of the telecommunications user device 10 is a native telecommunications function. The telecommunications function 11 is native in that it is a default telecommunications function, which may (or may not) have been pre-installed when the telecommunications user device 10 was acquired and may (or may not be) part of an operating system of the telecommunications user device 10. A native function may, in some cases, be referred to as a ‘built-in’, ‘out-of-the-box’ or ‘default’ function. The telecommunications function 11 may be operable to conduct telecommunications via a circuit-switched part of the telecommunications network 1. The circuit-switched part of the telecommunications network may comprise a public land mobile network (PLMN) and/or a public switched telephone network (PSTN). The telecommunications function 11 may be operable to conduct telecommunications via a packet-switched part of the telecommunications network 1. For example, the telecommunications function 11 may be operable to conduct Voice over Internet Protocol (VoIP) communications via a packet-switched part of the telecommunications network 1.

The native telecommunications function 11 is operable to conduct telecommunications with the telecommunications function 31 via the telecommunications function 21. The native telecommunications function 11 may be operable to conduct telephony communications, SMS communications, MMS communications, SIP-based communications (such as RCS) and/or other types of telecommunications.

The native telecommunications function 11 may be operable to receive a telecommunications identifier. The telecommunications identifier may relate to an entity with which a user of the telecommunications user device 10 wishes to communicate. For example, the native telecommunications function 11 may be operable to receive the telecommunications identifier from an address book function, a web browser function, a dial-by-voice function and/or another function of the telecommunications user device 10. As used herein, the term ‘telecommunications identifier’ means any identifier that can be used to identify an entity with which telecommunications can be conducted. Examples of such entities include users, user devices, telecommunications equipment, servers etc. As indicated above, such telecommunications may include any type of transfer of data, information, signals, messages, media etc. via any transfer medium. Examples of such telecommunications identifier include, but are not limited to, telephone numbers (which may identify a subscriber and/or subscriber device with which voice data may be communicated) and a URL (which may identify a web server with which web data may be communicated).

The data processing function 12 may be configured to communicate with the telecommunications network equipment 20 via a packet-switched network. The packet-switched network may comprise a public network, for example the Internet, and/or a private network. The data processing function 12 may be configured to communicate with the telecommunications network equipment 20 using a client-server connection. The data processing function 12 may be configured to communicate with the telecommunications network equipment 20 using HTTP, HTTPS, SIP, IMAP and/or XMPP.

The data processing function 12, the telecommunications function 21, the data processing function 22, the telecommunications function 31 and the data processing function 32 may be, respectively, native or non-native functions. In addition to the native telecommunications function 11, the telecommunications user device 10 may further comprise one or more additional native and/or non-native telecommunications functions.

In some examples, the native telecommunications function 11 and the data processing function 12 are comprised in a common software application on the telecommunications user device 10. The common software application may be a native software application. The common software application may be a dialer and/or messaging application.

In other examples, the native telecommunications function 11 and the data processing function 12 are comprised in separate software applications on the telecommunications user device 10. In such other examples, the data processing function 12 may be configured to use one or more APIs of the native telecommunications function 11 to communicate with the native telecommunications function 11. As such, as an alternative or in addition to providing suggestion functionality within the native telecommunications function 11, applications or functions installed alongside the native telecommunications function 11 may use APIs made available by the native telecommunications function 11 and/or APIs made available by the telecommunications user device 10 itself to provide the suggestion functionality described herein.

The data processing function 12 may be configured to transmit telecommunications data associated with the telecommunications conducted with the telecommunications function 31 of the telecommunications device 30. The data processing function 12 may be configured to transmit such telecommunications data to the telecommunications network equipment 20, for example to the data processing function 22.

The data processing function 12 may be configured to transmit the telecommunications data prior to messaging associated with the telecommunications being transmitted to the telecommunications network equipment 20. For example, the data processing function 12 may be configured to transmit the telecommunications data prior to the native telecommunications function 11 transmitting messaging associated with the telecommunications to the telecommunications network equipment 20. Alternatively or additionally, the data processing function 12 may be configured to transmit the telecommunications data after messaging associated with the telecommunications is transmitted to the telecommunications network equipment 20. For example, the data processing function 12 may be configured to transmit the telecommunications data after the native telecommunications function 11 transmits messaging associated with the telecommunications to the telecommunications network equipment 20.

The telecommunications data may comprise any data or information associated with such telecommunications including, but not limited to, a telecommunications identifier, location information and/or timing information.

The telecommunications data may comprise a telecommunications identifier associated with the telecommunications user device 10, the telecommunications network equipment 20, the telecommunications device 30 and/or another entity in the telecommunications network 1. The telecommunications identifier may be in the form of a telephony identifier, such as a telephony number. The telecommunications identifier may be in the form of a non-telephony identifier, such as a URL or uniform resource indicator (URI).

The telecommunications data may comprise location information associated with the telecommunications user device 10, the telecommunications network equipment 20, the telecommunications device 30 and/or another entity in the telecommunications network 1. The location information may be indicative of a physical location (either absolute or relative) of an entity to which it relates.

The telecommunications data may comprise timing information associated with the telecommunications conducted with the telecommunications function 31 of the telecommunications device 30. The timing information may be indicative of a start time, end time, duration and/or another timing aspect of such telecommunications.

The data processing function 12 is operable to cause, in response to a trigger event, data based on content received by the telecommunications user device 10 to be displayed on the telecommunications user device. The data based on the received content may be or may comprise the received content, or may be derived from the received content. For example, the received content may refer to one or more further resources the data processing function 12 should contact to retrieve the data that is to be displayed. For example, the received content may comprise a link to a website, an image and/or a remote messaging system with which the telecommunications user device 10 should start exchanging messages. In such cases, the data that is displayed on the telecommunications user device 10 may be the website, image and/or messages respectively. As such, the displayed data may not be the received content, but may be derived or obtained based on the received content (for example where the received content provides a link or pointer to such content). In some examples, the data that is to be displayed may be a notification to a user of the telecommunications user device 10, to notify the user that the content is available to be displayed and/or retrieved. The received content may be related to an entity associated with the telecommunications device 30. The telecommunications user device 10 may be configured to receive the content before, after and/or at the same time as the telecommunications are initiated.

The trigger event may comprise a communication event associated with the telecommunications conducted with the telecommunications function 31 of the telecommunications device 30. The communication event may comprise the data processing function 12 receiving data associated with a request to conduct the telecommunications.

To offer the suggestion functionality described herein at times where the telecommunications user device 10 is unable to receive the content, for example where the telecommunications user device 10 does not have access to the Internet, the telecommunications user device 10 may download such content in advance of telecommunications being conducted. For example, the telecommunications user device 10 may intermittently download such content. As such, the data processing function 12 may provide suggestion functionality even when, for example, Internet connectivity is not available at the time a phone call is initiated.

The content may be received by the data processing function 12 and/or may be received by another function of the telecommunications user device 10. The telecommunications user device 10 may be configured to generate an alert in response to, or otherwise in association with, displaying the data. The alert may be an audible alert, a haptic alert and/or another type of alert.

The received content may comprise a telecommunications identifier related to the entity associated with the telecommunications device 30.

The telecommunications identifier related to the entity associated with the telecommunications device 30 may be different from a telecommunications identifier comprised in an initial telecommunications request. The initial telecommunications request may comprise the telecommunications identifier the native telecommunications function 11 may receive from an address book function, a web browser function, a dial-by-voice function and/or another function of the telecommunications user device 10. The telecommunications identifier comprised in the initial telecommunications request may relate to the entity associated with the telecommunications device 30 and/or may relate to an entity that is different from the entity associated with the telecommunications device 30. Where the telecommunications identifier comprised in the initial telecommunications request relates to the entity associated with the telecommunications device 30, the telecommunications user device 10 and/or the telecommunications network equipment 20 may be operable to represent the telecommunications identifier comprised in the received content as an alternative telecommunications identifier to the telecommunications identifier comprised in the initial telecommunications request for telecommunications with the entity associated with the telecommunications device 30. The telecommunications network equipment 20 may be operable to select the alternative telecommunications identifier on the basis of a parameter associated with the telecommunications. Examples of such parameters include, but are not limited to, a telecommunications identifier, a location and a time. The initial telecommunications request may originate from the telecommunications user device 10, (for example from the native telecommunications function 11), from the telecommunications network equipment 20 (for example from the telecommunications function 21), the telecommunications device 30 (for example from the telecommunications function 31) and/or from another entity in the telecommunications network 1.

The data processing function 12 may be configured to pass the telecommunications identifier comprised in the received content to the native telecommunications function 11. Alternatively or additionally, the data processing function 12 may be configured to pass the telecommunications identifier comprised in the received content to a web browser function, a messaging function and/or another function of the telecommunications user device 10. Examples of such messaging functions include, but are not limited to, IM functions, SMS functions, MMS functions and SIP-based messaging functions.

The received content may comprise media content related to the entity associated with the telecommunications device 30. The media content may comprise text data, image data, audio data, video data and/or any other type of media data. The content may be rich content.

The data processing function 12 of the telecommunications user device 10 is operable to perform an action based on user input received by the telecommunications user device 10 in response to displaying the data. Where the data comprises a notification that the content is available, the user input may correspond to an indication that the content is to be displayed. As such, in some examples, both the data based on the content and the content itself may be displayed, for example one after the other. The displaying of the content may be conditional on the user providing predetermined user input, for example corresponding to an indication that the content is to be displayed.

The data processing function 12 may be operable to prevent (or ‘inhibit’) the telecommunications from being conducted with the telecommunications function 31 of the telecommunications device 30, for example by preventing the native telecommunications function 11 from conducting and/or initiating such telecommunications. The data processing function 12 may be operable to prevent such telecommunications from being conducted prior to the telecommunications user device 10 receiving the content, for example by preventing the native telecommunications function 11 from conducting and/or initiating such telecommunications prior to the telecommunications user device 10 receiving the content. Alternatively or additionally, the data processing function 12 may be operable to prevent such telecommunications from being conducted after the telecommunications user device 10 receives the content. The action performed by the data processing function 12 may be to prevent such telecommunications from being conducted, before or after the content is received, for example by preventing the native telecommunications function 11 from conducting and/or initiating such telecommunications.

The data processing function 12 may be operable to take control of the telecommunications conducted with the telecommunications function 31 of the telecommunications device 30. The data processing function 12 may be operable to take control of such telecommunications prior to the telecommunications user device 10 receiving the content. Alternatively or additionally, the data processing function 12 may be operable to take control of such telecommunications after the telecommunications user device 10 receives the content. The action performed by the data processing function 12 may be to take control of such telecommunications, before or after the content is received.

The data processing function 12 may be operable to cause the telecommunications conducted with the telecommunications function 31 of the telecommunications device 30 to be terminated. The data processing function 12 may be operable to cause such telecommunications to be terminated prior to the telecommunications user device 10 receiving the content. Alternatively or additionally, the data processing function 12 may be operable to cause such telecommunications to be terminated after the telecommunications user device 10 receives the content. The action performed by the data processing function 12 may be to cause such telecommunications to be terminated, before or after the content is received. The data processing function 12 may be operable to cause the native telecommunications function 11, the network equipment 20 and/or the telecommunications device 30 to terminate the telecommunications conducted with the telecommunications function 31 of the telecommunications device 30. The data processing function 12 may be able to cause a termination message to be transmitted to cause the telecommunications to be terminated.

The data processing function 12 may be operable to intercept messages associated with the telecommunications conducted with the telecommunications function 31 of the telecommunications device 30. The data processing function 12 may be operable to intercept messages intended to be processed by the native telecommunications function 11. The data processing function 12 may be operable to intercept messages output by the native telecommunications function 11.

The telecommunications user device 10 may be operable to modify a telecommunications log, such as a call log, to account for activity of the data processing function 12. For example, the telecommunications user device 10 may be able to delete a call entry from a call log where a call is initiated by the native telecommunications function 11 and intercepted by the data processing function 12 and the data processing function 12 prevents the call from being conducted. Without the call log being updated in this way, the call log may indicate that a call was conducted, when the data processing function 12 prevented the call from being conducted. The native telecommunications function 11, the data processing function 12 and/or another function of the telecommunications user device 10 may be able to update the log in this manner. The telecommunications user device 10 may be operable to update the log in this manner without requiring specific user input to update the log.

The telecommunications function 21 is operable to enable telecommunications to be conducted between the native telecommunications function 11 and the telecommunications function 31. The telecommunications function 21 may be operable to conduct telecommunications, for example with the native telecommunications function 11 and/or the telecommunications function 31, via a circuit-switched and/or packet-switched part of the telecommunications network.

The data processing function 22 is operable to enable, in response to a trigger event, content to be transmitted, for example from the telecommunications network equipment 20 and/or from further telecommunications network equipment, to the telecommunications user device 10 to enable data based on the content to be displayed on the telecommunications user device 10. The trigger event may comprise the telecommunications network equipment 20 receiving the content from the further telecommunications network equipment. The further telecommunications network equipment may be controlled by or otherwise associated with an enterprise, such as an enterprise a user of the telecommunications user device 10 may wish to correspond with, whereas the telecommunications network equipment 20 may be controlled by a network operator or other service provider. In some examples, the content transmitted to the telecommunications user device 10 (for example from the telecommunications network equipment 20 and/or from further telecommunications network equipment) comprises data arranged to identify the further telecommunications network equipment from which the data based on the content is obtainable.

As such, the telecommunications user device may comprise a native dialler and/or messaging function operable to cause one or more suggested telecommunications mechanisms and/or one or more telecommunications identifiers for telecommunications with a remote party to be displayed on the telecommunications user device, the one or more suggested telecommunications mechanisms and/or telecommunications identifiers being identified based on content received from one or more remote telecommunications network equipment.

Further, a smartphone may comprise a native dialler and/or messaging function operable to receive a first telephone number associated with a remote party and to output a communications request comprising the first telephone number. The smartphone may comprise a data processing function operable to download content from a remote server, the content comprising a second, different telephone number associated with the or another remote party, and to cause the smartphone to display an option to a user of the smartphone to use the second telephone number instead of the first telephone number.

In terms of an example envisaged use case of techniques described herein, a customer may call a business. The call may be blocked (or ‘inhibited’ or ‘prevented’), for example by the telecommunications user device 10. The telecommunications user device 10 may receive content in the form of visual IVR content. The visual IVR content may be useable by the telecommunications user device 10 to display a visual IVR. The visual IVR may comprise one or more menus of multiple different options selectable by the customer. The customer may work through the menu of options displayed by the visual IVR by selecting an item corresponding to a selectable option. The customer may then see further menus appear which they can navigate through in a similar manner. The customer may eventually choose to terminate the communication (in which case a phone call may not be placed to the business at all), to make a phone call and/or transfer the communication to another medium. Where the customer chooses to make a phone call, the phone call may be to the original number associated with the business or may be to a different number (associated with the same or another business). Where the customer chooses to transfer to another medium, the other medium may be, for example, messaging or a website.

In terms of another example envisaged use case of techniques described herein, a customer may call a business. In this example the call is not blocked but connects to an IVR system associated with the business that provides audio IVR content associated with the business. The customer also receives visual IVR content and sees a visual IVR menu of options which matches the audio IVR on a display of the telecommunications user device 10. The customer works through the menu of options by selecting items corresponding to selectable options and then sees further menus appear. The audio IVR moves on at the same time due to telephony events (for example digits) being injected into the call as a result of the reaction to such by the remote IVR equipment. The customer may eventually choose to terminate the communication (on the basis that they have already achieved their goal within the combined audio and visual IVR experience), to speak to an agent the call is passed to, or to terminate the phone call and transfer the communication to another medium including, for example, messaging or a website.

In terms of both example envisaged use cases described above, the customer may be able to input data (for example a name, account number etc.) during the engagement with the IVR equipment and the data used later in the engagement. As an example, a call center agent a customer eventually talks to may be able to see the full history of the communication so they can, for example, see the path the customer has taken through the IVR and/or see details the customer has entered while in the IVR (for example the customer name and/or account number).

As such, an IVR system may comprise a telecommunications function operable to enable audio IVR communications to be conducted with a native telecommunications function of a telecommunications user device. The IVR system may also comprise a data processing function operable to enable, in response to a trigger event (for example initiating the audio IVR communications), content to be transmitted to the telecommunications user device to enable data based on the content to be displayed on the telecommunications user device. The content may comprise visual IVR content comprising one or more menus, with each menu comprising one or more selectable options. The data to be displayed on the telecommunications user device may comprise a visual IVR based on the visual IVR content.

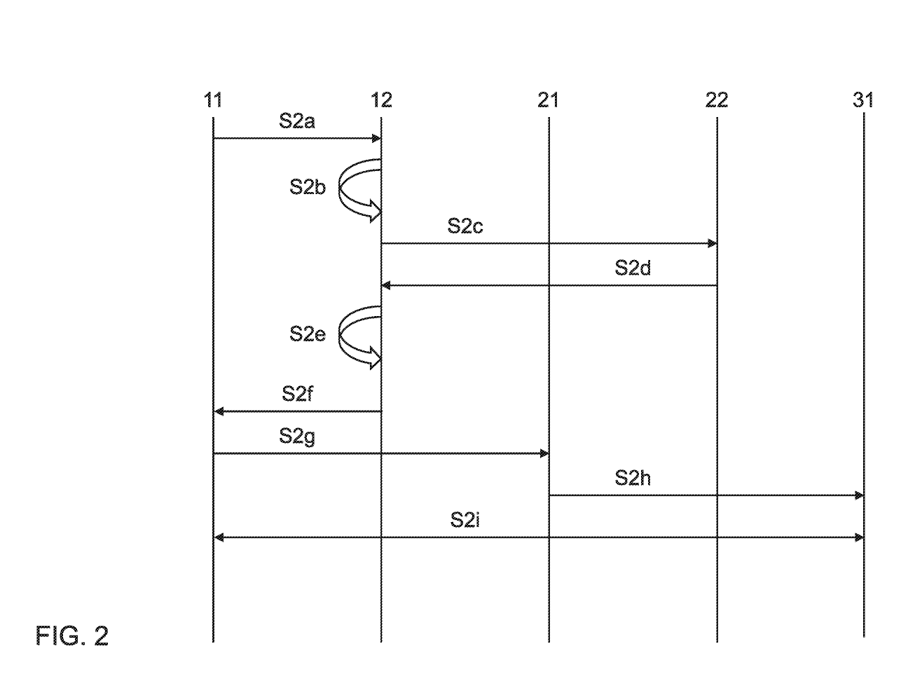

Referring to FIG. 2, there is shown an example of a method of controlling one or more of the telecommunications user device 10, the telecommunications network equipment 20 and the telecommunications device 30. In this example, the data processing function 12 intercepts a telecommunications request from the native telecommunications function 11 and, in response to user input, enables communications to be conducted between the telecommunications user device 10 and the telecommunications device 30.

At item S2a, the native telecommunications function 11 initiates a telecommunications request. For example, a user of the telecommunications user device 10 may enter a communications identifier into the native telecommunications function 11 or may identify a party with which they wish to communicate in another manner, for example using a dial-by-voice function and/or by identifying the party via the data processing function 12. The telecommunications request may be, for example, a telephone call set up request, an SMS request, an MMS request, a SIP-based messaging request (such as an RCS request).

At item S2b, the data processing function 12 intercepts the telecommunications request associated with item S2a. The data processing function 12 may be able to inspect and/or manipulate data comprised in the telecommunications request. By intercepting the telecommunications request, the data processing function 12 can halt, permanently or temporarily, initiation of the telecommunications.

At item S2c, the data processing function 12 transmits telecommunications data associated with the telecommunications to the data processing function 22. The data processing function 12 may, for example, be able to identify a predetermined network address associated with the data processing function 22 to which the telecommunications data is to be transmitted.

At item S2d, the data processing function 22 transmits content to the data processing function 12. The content may be based on information comprised in the telecommunications data. Default content may be provided if no entity-specific or user-specific content is identified based on the information comprised in the telecommunications data. The content may comprise a telecommunications identifier that is different from a telecommunications identifier comprised in the telecommunications data, for example where the telecommunications network equipment 20 suggests an alternative telecommunication identifier to that indicated initially.

At item S2e, the data processing function 12 causes data based on the content to be displayed on the telecommunications user device 10. In this example, the trigger event, in response to which the data processing function 12 causes data based on the content to be displayed, is the receipt of the content by the data processing function 12. For example, an alternative telecommunications identifier and/or telecommunications mechanism may be suggested to the user of the telecommunications user device 10. In some examples, the received content may comprise data identifying a resource or location from which the data to be displayed may be retrieved. In such examples, the data processing function 12 may cause the data to be displayed to be retrieved and the retrieving of the data may comprise the trigger event. As such, in response to retrieving the data, the data may be displayed on the telecommunications user device 10.

At item S2f, the data processing function 12 performs an action based on user input received by the telecommunications user device 10 in response to the displaying of the data associated with item S2e. The user input may be associated with the user selecting one of multiple displayed options, for example by the user touching a region of a touch-sensitive display corresponding to the selected option. In this example, the action performed by the data processing function 12 at item S2f comprises passing the telecommunications identifier comprised in the received content to the native telecommunications function 11. In other examples, for example where the user of the telecommunications user device 10 does not wish to use an alternative telecommunications identifier, the data processing function 12 may pass the initial telecommunications identifier to the native telecommunications function 11.

At item S2g, the native telecommunications function 11 initiates telecommunications based on the telecommunications identifier comprised in the received content by transmitting a telecommunications request comprising the telecommunications identifier to the telecommunications function 21. Initiating communications may comprise transmitting a telephone call setup request, an SMS, an MMS and/or a SIP-based (for example RCS) message.

At item S2h, the telecommunications function 21 transmits a telecommunications request, based on the telecommunications request of item S2g, to the telecommunications function 31. The telecommunications function 21 may forward the request of item S2g and/or may modify the request.

At item S2i, telecommunications are conducted between the native telecommunications function 11 and the telecommunications function 31. Conducting communications may involve establishing a communications session, such as a voice and/or video call. Alternatively, conducting communications may not involve establishing a ‘live’ communication session as such, for example where SMS, MMS and/or SIP-based (for example RCS) communications are performed.

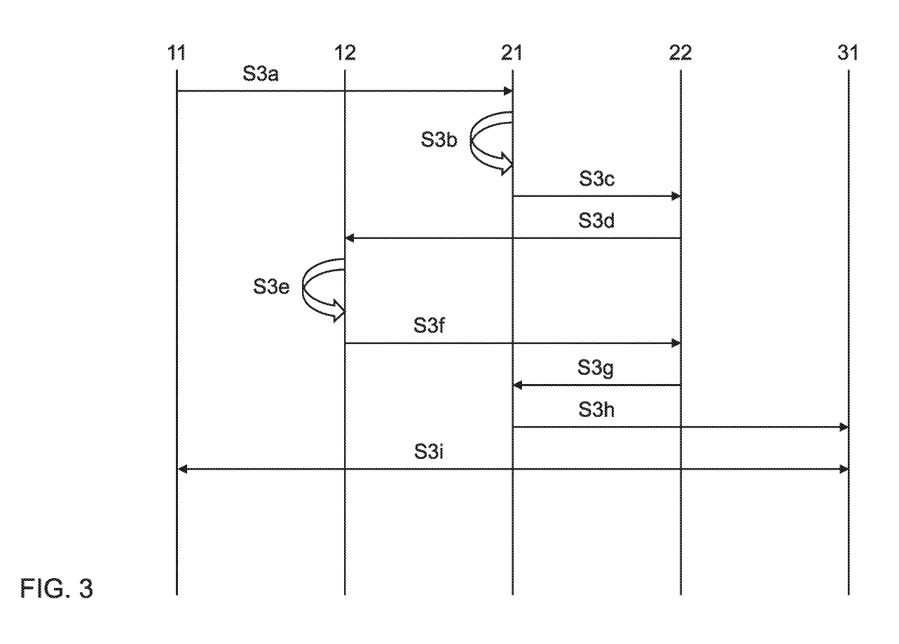

Referring to FIG. 3, there is shown an example of a method of controlling one or more of the telecommunications user device 10, the telecommunications network equipment 20 and the telecommunications device 30. In this example, the telecommunications function 21 intercepts a telecommunications request from the native telecommunications function 11 and, in response to user input, enables communications to be conducted between the telecommunications user device 10 and the telecommunications device 30.

At item S3a, the native telecommunications function 11 initiates a telecommunications request.

At item S3b, the telecommunications function 21 intercepts the telecommunications request associated with item S3a. In this example, the native telecommunications function 11 has transmitted the telecommunications request to the telecommunications function 21 and the telecommunications request has not been intercepted by the data processing function 12.

At item S3c, the telecommunications function 21 transmits telecommunications data associated with the telecommunications request to the data processing function 22.

At item S3d, the data processing function 22 transmits content to the data processing function 12. The content may comprise an alternative telecommunications identifier to a telecommunications identifier comprised in the telecommunications data.

At item S3e, the data processing function 12 causes data based on the content to be displayed on the telecommunications user device 10. In this example, the trigger event, in response to which the data processing function 12 causes data based on the content to be displayed, is the receipt of the content by the data processing function 12.

At item S3f, the data processing function 12 performs an action based on user input received by the telecommunications user device 10 in response to the displaying of the data associated with item S3e. In this, example the action performed by the data processing function 12 at item S3f comprises transmitting data to the data processing function 22 to indicate that the user of the telecommunications user device 10 wishes to conduct telecommunications with the telecommunications user device 30.

At item S3g, the data processing function 22 transmits data to the telecommunications function 21 to indicate that the user of the telecommunications user device 10 wishes to conduct telecommunications with the telecommunications user device 30.

At item S3h, the telecommunications function 21 transmits a telecommunications request, based on the data of item S3g, to the telecommunications function 31.

At item S3i, telecommunications are conducted between the native telecommunications function 11 and the telecommunications function 31.

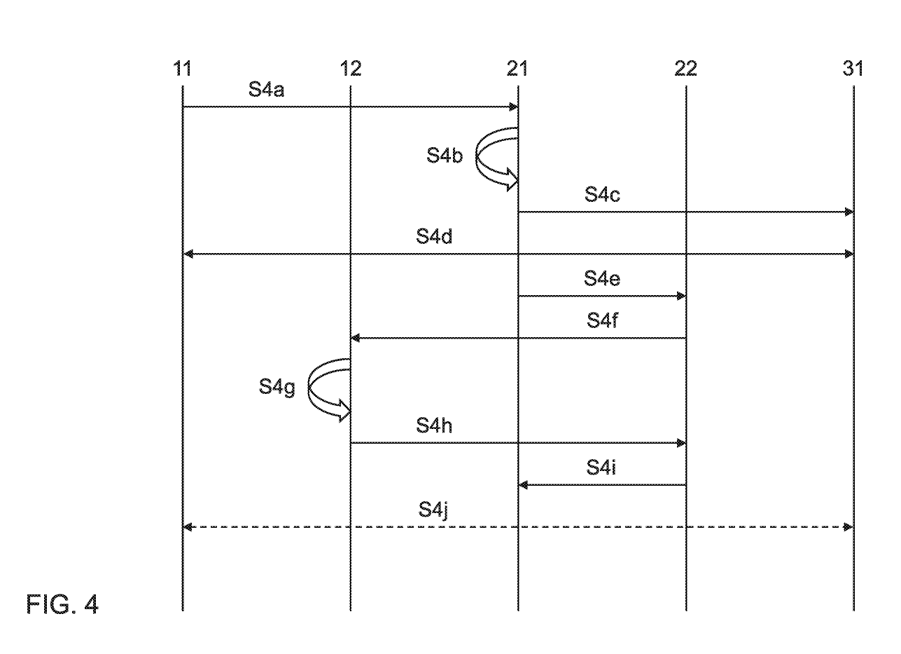

Referring to FIG. 4, there is shown an example of a method of controlling one or more of the telecommunications user device 10, the telecommunications network equipment 20 and the telecommunications device 30. In this example, the telecommunications function 21 intercepts a telecommunications request from the native telecommunications function 11 and, in response to user input, causes telecommunications conducted between the telecommunications user device 10 and the telecommunications device 30 to be terminated.

At item S4a, the native telecommunications function 11 initiates a telecommunications request.

At item S4b, the telecommunications function 21 intercepts the telecommunications request associated with item S4a.

At item S4c, the telecommunications function 21 transmits data based on the telecommunications request associated with item S4a to the telecommunications function 31.

At item S4d, telecommunications are conducted between the native telecommunications function 11 and the telecommunications function 31.

At item S4e, the telecommunications function 21 transmits telecommunications data associated with the telecommunications request to the data processing function 22. In this example, the telecommunications data is transmitted to the data processing function 22 after the telecommunications are established at item S4d, for example after a telephone call has been established between the telecommunications function 11 and the telecommunications function 31.

At item S4f, the data processing function 22 transmits content to the data processing function 12. In this example, the content is transmitted to the data processing function 12 after the telecommunications are established at item S4d, for example after a telephone call has been established between the telecommunications function 11 and the telecommunications function 31.

At item S4g, the data processing function 12 causes data based on the content to be displayed on the telecommunications user device 10. In this example, the trigger event, in response to which the data processing function 12 causes data based on the content to be displayed, is the receipt of the content by the data processing function 12. In this example, the data is displayed after the telecommunications are established at item S4d, for example after a telephone call has been established between the telecommunications function 11 and the telecommunications function 31.

At item S4h, the data processing function 12 performs an action based on user input received by the telecommunications user device 10 in response to the displaying of the data associated with item S4g. In this, example the action performed by the data processing function 12 at item S4h comprises transmitting data to the data processing function 22 to indicate that the user of the telecommunications user device 10 wishes to terminate the telecommunications with the telecommunications user device 30.

At item S4i, the data processing function 22 transmits data to the telecommunications function 21 to indicate that the user of the telecommunications user device 10 wishes to terminate telecommunications with the telecommunications user device 30.

At item S4j, the telecommunications function 21 causes the telecommunications with the telecommunications user device 30 to be terminated as indicated in FIG. 4 by the use of broken lines.

Although, in this example, the data processing function 12 transmits data to the data processing function 22 to indicate that the user of the telecommunications user device 10 wishes to terminate the telecommunications with the telecommunications user device 30, in other examples, the data processing function 12 may transmit such termination data to the native telecommunications function 11. In turn, the native telecommunications function 11 may terminate the telecommunications.

The functions described herein may be comprised in or implemented in an apparatus comprising a processor or processing system. The processing system may comprise one or more processors and/or memory. Each device, module or function as described in relation to any of the examples described herein may similarly comprise a processor and/or processing system or may be comprised in apparatus comprising a processor and/or processing system. One or more of the aspects of the embodiments described herein with reference to the drawings comprise processes performed by apparatus. In some examples, the apparatus comprises one or more processing systems or processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also extend to computer programs, particularly computer programs on or in a carrier, adapted for putting the above described embodiments into practice. The program may be in the form of non-transitory source code, object code, or in any other non-transitory form suitable for use in the implementation of processes according to embodiments. The carrier may be any entity or device capable of carrying the program, such as a RAM, a ROM, or an optical memory device, etc.

The above embodiments are to be understood as illustrative examples of the invention. Further embodiments of the invention are envisaged.

In examples described above, the telecommunications network 1 comprises two telephony devices 10, 30 and telecommunications network equipment 20. In other examples, the telecommunications network 1 comprises more than two telephony devices and/or additional telecommunications network equipment.

In examples described above, telecommunications may be terminated. For example a voice and/or video call may be terminated where a user wishes to speak to a different entity following a suggestion from the telecommunications network equipment 20. In some examples, the telecommunications cannot be terminated at the point at which the user indicates that they wish to use an alternative telecommunications identifier and/or telecommunications mechanism. For example, an SMS, MMS and/or SIP-based (for example RCS) message may have been transmitted to an originally intended recipient and the user may then indicate that they wish to communicate with another recipient based on a suggestion from the telecommunications network equipment 20. In such examples, the user may be able to initiate further telecommunications using the alternative telecommunications identifier and/or telecommunications mechanism, for example by sending an additional SMS, MMS or SIP-based (for example RCS) message.

In examples described above, telecommunications are initiated by the telecommunications user device 10. In other examples, the telecommunications could be initiated by the telecommunications network equipment 20 (for example where the telecommunications network equipment 20 dials out to both the telecommunications user device 10 and the telecommunications device 30) or by the telecommunications device 30.

In some examples, the suggestion functionality described herein is selectively provided. For example, the suggestion functionality may be overridden where the user of the telecommunications user device 10 wishes to communicate with an emergency service, a party whose contact details are stored locally on the telecommunications user device 10 and/or a party who the user of the telecommunications user device 10 should not be subject to the suggestion functionality processing described herein.

In examples described above, the native telecommunications function 11 is or is comprised in a native dialler application. In other examples, the native telecommunications function 11 is or is comprised in another type of native telecommunications application, such as a native messaging application. An example of such a native messaging application is a native application that enables communication of SMS, MMS and/or SIP-based messages (for example RCS). As such, the suggestion functionality described herein may be provided when a user initiates communications via a native messaging application and/or via a native dialer application.

In examples described above, data based on content received by a telecommunications user device 10 is displayed on the telecommunications user device 10 and an action is performed based on user input received by the telecommunications user device 10 in response to displaying the data. Examples of such an action, as described above, include causing telecommunications to be terminated or initiated. In some examples, the action that is performed based on the user input may be causing the data not to be displayed. For example, the data may be displayed to a user alongside or in parallel with the telecommunications that are being conducted and the user may provide input to cause the data to no longer be displayed. In such examples, the telecommunications (for example a telephone call) may be allowed to go ahead in a conventional manner without interruption or reprogramming while still allowing an enhanced user experience by providing additional data in conjunction with the telecommunications being conducted.

In examples described above, the data processing function 12 may, for example, intercept messages, inhibit telecommunications communications, cause telecommunications to be terminated etc. In some examples, the data processing function 12 may be a function of the telecommunications user device 10 that is used to interact with the user, for example by displaying data to the user and receiving user input based on the displayed data. For example, the data processing function 12 may receive a notification from another entity in the telecommunications network 1 that content is available for display on the telecommunications user device 10. The data processing function 12 may cause a notification to be displayed to a user of the telecommunications user device 10 to indicate that the content is available. If the user agrees to view the content (which may constitute a trigger event as described herein), the telecommunications user device 10 may receive the content and the data processing function 12 may cause the content to be displayed to the user of the telecommunications user device 10.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A telecommunications user device comprising:
a native telecommunications function operable to establish a telephone call with a telecommunications function of a telecommunications device via a telecommunications function of telecommunications network equipment; and
a data processing function operable to:
receive content from the telecommunications network equipment and/or further telecommunications network equipment;
cause data based on the content received by the telecommunications user device to be displayed on the telecommunications user device after the telephone call is established between the native telecommunications function and the telecommunications function of the telecommunications device, the displayed data comprising an indication of an alternative telecommunications mechanism for conducting telecommunications with an entity associated with the telecommunications device, the alternative telecommunications mechanism being different from a telephone call; and
cause the telephone call established with the telecommunications function of the telecommunications device to be terminated based on user input received by the telecommunications user device in response to the displaying of the data.

2. The telecommunications user device of claim 1, wherein the data processing function is operable to take control of the telephone call.

3. The telecommunications user device of claim 1, wherein the data processing function is operable to cause the native telecommunications function, the telecommunications network equipment and/or the telecommunications device to terminate the telephone call.

4. The telecommunications user device of claim 1, wherein the data processing function is operable to cause a termination message to be transmitted in order to cause the telephone call to be terminated.

5. The telecommunications user device of claim 1, wherein the data processing function is operable to intercept messages associated with the telephone call.

6. The telecommunications user device of claim 1, wherein the data processing function is operable to intercept messages output by the native telecommunications function.

7. The telecommunications user device of claim 1, wherein the telecommunications network equipment is controlled by a mobile network operator.

8. The telecommunications user device of claim 1, wherein the received content comprises a telecommunications identifier related to the entity associated with the telecommunications device.

9. The telecommunications user device of claim 8, wherein the telecommunications identifier comprises a telephony identifier.

10. The telecommunications user device of claim 8, wherein the telecommunications identifier comprises a non-telephony identifier.

11. The telecommunications user device of claims 8, wherein the telecommunications identifier is different from a telecommunications identifier comprised in an initial telecommunications request.

12. The telecommunications user device of claim 11, wherein the telecommunications identifier comprised in the initial telecommunications request is related to the entity associated with the telecommunications device.

13. The telecommunications user device of claim 11, wherein the telecommunications user device is operable to represent the telecommunications identifier comprised in the received content as an alternative telecommunications identifier to the telecommunications identifier comprised in the initial telecommunications request for telecommunications with the entity associated with the telecommunications device.

14. The telecommunications user device of claim 1, wherein the telecommunications user device is configured to generate an alert in response to the displaying of the data.

15. The telecommunications user device of claim 1, wherein the data processing function is configured to transmit telecommunications data associated with the telephone call to the telecommunications network equipment.

16. The telecommunications user device of claim 15, wherein the telecommunications data comprises:
a telecommunications identifier associated with the telecommunications user device, the telecommunications network equipment and/or the telecommunications device;
location information associated with the telecommunications user device, the telecommunications network equipment and/or the telecommunications device; and/or
timing information associated with the telephone call.

17. The telecommunications user device according to claim 1, wherein the data processing function is configured to communicate with the telecommunications network equipment using a client-server connection.

18. The telecommunications user device according of claim 1, wherein the data processing function is configured to communicate with the telecommunications network equipment using hypertext transfer protocol, secure hypertext transfer protocol, session initiation protocol, Internet message access protocol and/or extensible messaging and presence protocol.

19. A method of controlling a telecommunications user device, the telecommunications user device comprising:
a native telecommunications function operable to establish a telephone call with a telecommunications function of a telecommunications device via a telecommunications function of telecommunications network equipment; and
a data processing function,
wherein the method comprises:
the data processing function receiving content from the telecommunications network equipment and/or further telecommunications network equipment;
the data processing function causing data based on the content received by the telecommunications user device to be displayed on the telecommunications user device after the telephone call is established between the native telecommunications function and the telecommunications function of the telecommunications device, the displayed data comprising an indication of an alternative telecommunications mechanism for conducting telecommunications with an entity associated with the telecommunications device, the alternative telecommunications mechanism being different from a telephone call; and
the data processing function causing the telephone call established with the telecommunications function of the telecommunications device to be terminated based on user input received by the telecommunications user device in response to the displaying of the data.

20. A non-transitory computer-readable storage medium comprising a set of computer-readable instructions stored thereon, which, when executed by a processing system, cause the processing system to perform a method of controlling a telecommunications user device, the telecommunications user device comprising:
a native telecommunications function operable to establish a telephone call with a telecommunications function of a telecommunications device via a telecommunications function of telecommunications network equipment; and
a data processing function,
wherein the method comprises:
the data processing function receiving content from the telecommunications network equipment and/or further telecommunications network equipment;
the data processing function causing data based on the content received by the telecommunications user device to be displayed on the telecommunications user device after the telephone call is established between the native telecommunications function and the telecommunications function of the telecommunications device, the displayed data comprising an indication of an alternative telecommunications mechanism for conducting telecommunications with an entity associated with the telecommunications device, the alternative telecommunications mechanism being different from a telephone call; and
the data processing function causing the telephone call established with the telecommunications function of the telecommunications device to be terminated based on user input received by the telecommunications user device in response to the displaying of the data.
